(19) United States
(12) Patent Application Publication
(10) Pub. No.: US 2026/0184946 A1
(43) Pub. Date: Jul. 2, 2026

(54) CONDUCTIVE INK

(71) Applicant: Swansea University, Swansea (GB)

(72) Inventor: James Claypole, Swansea (GB)

(73) Assignee: Swansea University, Swansea (GB)

(21) Appl. No.: 19/131,128

(22) PCT Filed: Nov. 17, 2023
(86) PCT No.: PCT/GB2023/053024

§ 371 Date: May 19, 2025

(30) Foreign Application Priority Data
Nov. 21, 2022 (GB) 2217404.9

(51) Int. Cl. C09D 11/52; C09D 5/23; C09D 5/24; C09D 11/037

(52) U.S. Cl. CPC C09D 11/52; C09D 5/23; C09D 5/24; C09D 11/037

(57) ABSTRACT

The invention relates to an ink composition for printing conductive tracks with high electrical conductivity for electronic applications, and which can be recycled to recover the conductive particles via an environmentally friendly extraction process for re-use, without further processing, in a further conductive ink composition. Also provided are substrates comprising a printed current track formed from such compositions; substrates comprising a surface mount electronic component adhered to said substrate via contact with an adhesive composition formed from such ink compositions; and substrates comprising a conductive coating formed from such ink compositions for use in, e.g., induction sealing and/or to provide an antimicrobial coating. Methods of forming such printed tracks, coated substrates and/or adhering surface mount components to a substrate are also provided.

The invention relates to an ink composition for printing conductive tracks with high electrical conductivity for electronic applications, and which can be recycled to recover the conductive particles via an environmentally friendly extraction process for re-use, without further processing, in a further conductive ink composition. Also provided are substrates comprising a printed track formed from such ink compositions; substrates comprising a surface mount electronic component adhered to said substrate via contact with an adhesive composition formed from such ink compositions; and substrates comprising a conductive coating formed from such ink compositions for use in, e.g., induction sealing and/or to provide an antimicrobial coating. Methods of forming such printed current tracks, coated substrates and/or adhering surface mount components to a substrate are also provided.

### BACKGROUND OF INVENTION

An increasing number of electronic devices are relying on flexible, low cost printed circuit film technology. The circuits themselves are printed onto the film and use silver, copper or gold as the conductors. Examples in consumer electronics include wearables, RFID aerials, energy harvesting, sensors and solar panels. Surface mount components are then glued to the film using conductive adhesive. The consumer demand and ever-increasing number of short life disposable electronics has resulted in the generation of a huge amount of electronic waste (e-waste). Around 54 Mt of e-waste was generated in 2019 and was due to increase at a rate of 2 Mt per year, of which less than 25% of this was recycled.

Printed electronics provides a means to reduce the environmental impact from the generation of e-waste by offering biodegradable and recyclable solutions. This is where a functional (conductive, dielectric or semiconducting) material is applied from either a digital or physical pattern onto a carrier substrate. Work in this area has already been accomplished in looking at recycled substrates [2] [3] and carbon-based printing inks [4] [5]. Carbon based inks have significantly lower conductivity [6] when compared to metallic inks such as silver, gold and copper. These metallic inks can either be in the form of micro-flakes, which form an interconnecting structure, or nanoparticles, which are sintered to form a solid conductive layer. These highly conductive inks are used in interconnects between components, printed RFID aerials, energy harvesting, sensors and solar panels.

However, the extraction of these metals from the printed electronics is no different from that used for other electronics waste and uses highly corrosive and toxic chemicals, commonly referred to as piranha solution, to dissolve the waste including the substrate and the ink. For example, the current methods of extraction of silver from e-waste comprises of producing a leach liquor from the waste materials using Cyanide, Hydrochloric acid, Thiosulphate or Thiourea. This process dissolves both the silver and substrate, thereby preventing the substrate from being recycled within its own waste stream. The silver is extracted and purified from the leach liquor using cementation, ion-exchange and solvent extraction, thus involving further toxic chemicals. In addition to the heavy use of toxic chemicals, the recovered silver requires further processing, such as smelting to refine the silver and remove traces of the chemicals used in the extraction, for it to be used again in printed electronics. There is therefore an unmet need for a conductive ink that can be readily recycled from printed electronics without the need for toxic recovery methods.

We herein disclose a unique formulation for a highly conductive water-based silver ink and the methodology for a chemical free extraction process to enable the recycling of the silver from printed electronics, offering an alternative to silver conductive inks currently used in electronics, which use toxic chemicals in the recovery of the precious metals. In particular, the printed ink can be simply recovered by magnetic recovery methods using no chemicals in the extraction process, allowing for recovery of the ink from the substrate (onto which they are printed), advantageously allowing the ink to be recycled for further use without further processing, reducing energy use and material cost. Following extraction of the ink, the substrate can be returned to its own waste stream for recycling. This therefore paves the way for the first fully recyclable printed electronics, with the ink and subsequent method of recovery, providing an environmentally sustainable alternative to silver, copper and gold conductive inks currently used in the manufacture of printed electronics. This includes devices such as consumer electronics, Smart devices, Smart packaging, sensors, point of care health, wearable, RFID aerials, membrane switches and circuit boards.

### STATEMENTS OF INVENTION

The present invention, in its various aspects, is as set out in the accompanying claims.

According to a first aspect of the invention there is provided an ink composition for use in printing conductive tracks, providing a surface coating and/or for use as a conductive adhesive to attach surface mount components to a substrate, wherein the ink composition has high electrical conductivity for electronic applications, and which can be recycled to recover the conductive particles via an environmentally friendly extraction process for re-use, without further processing, in a further conductive ink composition.

The ink composition of the invention comprises: (a) one or more coated magnetic particles; (b) one or more binders; and (c) one or more solvents, wherein said particles are coated with one or more electrically conductive metals.

The magnetic particles are not particularly limited, and as such may comprise any magnetic metal core and/or may be coated with any electrically conductive metal. Suitable magnetic metals include, but are not limited to, iron (Fe), nickel (Ni) and alloys thereof. Similarly, suitable electrically conductive metals include, but are not limited to, silver (Ag), gold (Au), copper (Cu), aluminium (Al) and alloys thereof. However, in preferred embodiments the magnetic particles comprise iron or an iron alloy, and/or the electrically conductive metal is silver or an alloy thereof. Silver coated iron (AgFe), including silver coated iron microparticles (AgFe MPs) and silver coated iron nanoparticles (AgFe NPs) which are readily obtainable from multiple commercial sources, are particularly preferred.

As used herein, the term nanoparticles refers to particles that are between about 1 and about 1,000 nm in diameter,

Similarly, as used herein the term microparticles refers to particles that are between about 1 and about 500 μm, and preferably between about 5 and 250 μm, in diameter.

The coated magnetic particles are bifunctional. Firstly, because of the magnetic metal core, the particles are magnetic and provides for a property that is exploited in processes for recovering said particles for re-use in conductive ink compositions. Secondly, due to the conductive metal coating, the particles provide the ink composition sufficient conductivity to enable printing of an electrically conductive line, shape, pattern or circuit onto a substrate. Moreover, as will be readily appreciated by the skilled reader, the overall electrical conductivity and magnetic properties of the particles can be fine-tuned by varying the proportional amount of magnetic core with respect to the conductive coating: Particles comprising a high proportion of magnetic metal core and a low proportion of the coating conductive metal will be highly magnetic (and so will be more easily recovered using lower powered magnets), but will have a higher resistivity when deposited as a conductive track on a substrate.

A good balance of magnetic and conductive properties, which enables the particles to be used in a conductive ink and to be recovered and recycled, is achieved using coated particles wherein the weight ratio of the magnetic metal of the core to the conductive metal of the coating is from about 5:95 to about 40:60 or from about 10:90 to about 30:70. In a particularly preferred embodiment, the coated particles comprise magnetic metal, preferably iron, and conductive metal, preferably silver, in weight ratio of about 20:80.

The overall conductivity of the ink, and by extension any conductive composition printed from same, will also depend on the particle concentration in said ink composition. For example, preferred ink compositions comprise the coated magnetic particles in an amount from about 40 to about 80 wt. %, and more preferably about 60 wt. %, based on the total weight of the ink composition, has a conductivity in the region of half that of conventional silver inks, and so is a viable alternative as a highly conductive ink.

The size of the coated magnetic particles is not particularly limited, and the skilled person will select an appropriate particle size or particle sizes according to ones needs. However, in exemplary embodiments of the invention, the conductive ink comprises coated magnetic microparticles or nanoparticles, preferably microparticles, and most preferable microparticles having an average particle size, measured using a Malvern Morphologi 4 particle size analyser, of from about 10 μm to about 40 μm, and more preferably about 25 μm.

In the ink composition of the invention, the coated magnetic particles are dispersed in one or more binders or resin components. Such binders provide adhesion to the substrate and, dependent on concentration, the required rheological properties to the ink composition. As will be readily appreciated by the skilled person, the type of binder is not particularly limited, provided that said binder is soluble in the chosen solvent, and allows printing of the ink formulation onto a substrate such as paper, plastic and/or fabric surfaces.

However, in preferred embodiments the binder or resin comprises or consists of one or more hydrophilic polymer, examples of which include polyvinyl alcohol, polyvinyl pyrrolidone, gelatin, celluloses, pectins, polyoxazolines, polyvinylacetamides, partially hydrolyzed polyvinyl acetate/vinyl alcohol, polyacrylic acid, polyacrylamide, polyalkylene oxide, sulfonated or phosphated polyesters and polystyrenes, casein, zein, albumin, and derivatives thereof. More preferably, the binder comprises one or more cellulose and/or one or more pectin.

Preferably the cellulose is a cellulose ether, and still more preferably is a carboxymethyl cellulose (i.e. a cellulose derivative in which a carboxymethyl [—CH₂—COOH] or a metal salt thereof [e.g. —CH₂—COONa] is bound to one or more hydroxyl groups of the glucopyranose monomer forming the cellulose backbone). Particularly preferred cellulose, cellulose ether and carboxymethyl cellulose binders have a Mw of from about 50,000 to about 150,000 Da.

Similarly, the ink composition is not particularly limited in terms of the type of solvent used, provided that (a) the binder is sufficiently soluble in the solvent to prepare a composition of required rheological properties, and (b) the solvent is compatible with a substrate such as a paper, plastic and/or fabric surface. However, in preferred examples, the solvent is water.

As noted above, the binder is provided in an amount sufficient to control the rheological profile of the ink composition. In preferred examples, the ink composition is a shear thinning composition, and more preferably is a shear thinning composition with a shear viscosity of between about 80 and about 2 Pa·s, alternatively between about 45 and about 4 Pa·s, over a shear range of 0.1 to 100 s⁻¹ as this ensures compatibility with screen printing processes, which are commonly used in the printing of electronic circuitry. Shear viscosities can be measured using a shear rheometer, e.g., a Netzsch Kinexus Pro.

The ink of the first aspect of the invention is configured for use to print an electrically conductive composition onto a substrate. Such printed compositions may form an electrically conductive track and/or a surface coating and/or may be used as an electrically conductive adhesive to attach surface mount components to a substate. Therefore, according to a second aspect, the invention provides a substrate comprising an electrically conductive composition deposited thereon, wherein said composition comprises a cured ink composition according to the first aspect.

In some embodiments, the electrically conductive composition forms a conductive track, i.e., a line, shape, pattern or circuit.

In other embodiments, the electrically conductive composition is an adhesive composition in direct contact with, and thereby resiliently joining, the substrate and a surface mount component. The use of such an ink composition as a conductive surface mount adhesive allows for the recovery/recycling of both the conductive particles and adhered surface mount components via the environmentally friendly extraction processes of the present invention.

In further embodiments the electrically conductive composition forms a conductive coating on the surface of the substrate. Such coatings may advantageously be applied to a thermoplastic substrate for use in induction sealing (thereby replacing the aluminium layer conventionally used) in, e.g., tamperproof packing and hermetic sealing of food packaging.

Further, particularly where a coating is formed from silver or copper coated magnetic particles, the coating may provide an antimicrobial effect due to the well-documented antimicrobial activity of such metals. Therefore, such coatings would be particularly suitable for application to medical devices, which are commonly single use products and so enable the recovery/recycling of the conductive/antimicrobial particles via the environmentally friendly extraction processes of the present invention.

The ink compositions, e.g. conductive tracks, adhesives or coatings, can be deposited onto a wide variety of substrate surfaces, including but not limited to paper, plastics, metals and fabrics. However, to assist in recycling and recovery of the ink components, the substrate is preferably paper.

The electrically conductive composition, e.g., conductive track, adhesive or coating may be printed onto a substrate by a method, which represents the third aspect of the invention. Such a method comprises: (a) printing an ink composition according to the first aspect onto the surface of a substrate; and then (b) curing said ink composition. The electrically conductive composition may form a conductive track, i.e., a line, shape, pattern or circuit or a conductive coating, or a conductive adhesive composition for surface mount components.

As will be readily appreciated, where the conductive composition forms such conductive adhesive, said method further comprises: (a) printing an ink composition according to the first aspect onto the surface of a substrate; (a1) depositing a surface mount component onto said printed ink composition; and then (b) curing said ink composition thereby resiliently joining the substrate and surface mount component.

In preferred methods, the ink is deposited onto the surface of the substrate in step (a) by screen printing.

As will be readily appreciated, curing of the deposited ink composition in step (b) may occur passively, i.e., at ambient temperature without the application of heat. However, in preferred embodiments, curing step (b) comprises the application of heat in order to accelerate the curing process. In particularly preferred embodiments, the printed substrate is placed in a closed environment (e.g. a drying oven), heated to a temperature of at least about 50° C., and preferably at least about 75° C. Preferably the temperature is no more than about 125° C., and more preferably no more than about 100° C., to avoid thermal degradation of the substrate and/or ink and for environmental considerations.

The ink composition of the first aspect has been configured not only for printing conductive tracks and coatings and/or as an adhesive composition with high electrical conductivity for, e.g., electronic applications, but also to enable recycling and recovery of the conductive particles (and surface mount components secured using such conductive inks as an adhesive) from ‘end of life’ substrates such as printed electronics via an environmentally friendly extraction process for re-use, without further processing, in a further conductive ink composition.

Therefore, according to a fourth aspect the invention provides a method for recycling conductive metal particles for re-use in a conductive ink composition, wherein the method comprises:
(a) providing a substrate according to the second aspect of the invention;
(b) submerging said substrate in a solvent to dissolve said substrate and/or the binder component of the cured ink composition, thereby forming a recovery media comprising free coated magnetic particles;
(c) separating said conductive metal particles from the recovery media by the application of a magnetic force; and
(d) optionally drying the recovered metal particles.

As will be readily appreciated by the skilled reader, drying step (d) is preferably provided when the recovered conductive metal particles are to be stored in a dry form for subsequent use. Similarly, such a drying step is preferably provided when the recovered conductive metal particles are to be combined with one or more binders and one or more solvents to prepare a recycled conductive ink composition, when the solvent used in recovery step (b) is different to that used in the recycled conductive ink composition.

The method may further comprise an optional washing step after separation step (c) and, if present, prior to drying step (d).

In preferred embodiments, the solvent used in step (b) is water. Additionally or alternatively, heat is preferably applied in step (b) to accelerate the dissolution process. For example, the solvent can be heated to a temperature of from about 50° C. to about 90° C.

It has been found that the recovered coated metal particles are unaltered as a result of the magnetic recovery process of the invention, and so are suitable for re-use in a new ink formulation without further processing steps. Therefore, the recycling method of the fourth aspect of the invention may further comprise, after step (c) and, if present, step (d), combining the recovered conductive metal particles with one or more binders and one or more solvents to prepare an ink composition according to the first aspect of the invention.

Throughout the description and claims of this specification, the words “comprise” and “contain” and variations of the words, for example “comprising” and “comprises”, mean “including but not limited to” and do not exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The invention will now be described, by way of example only, with reference to the following figures and tables wherein:

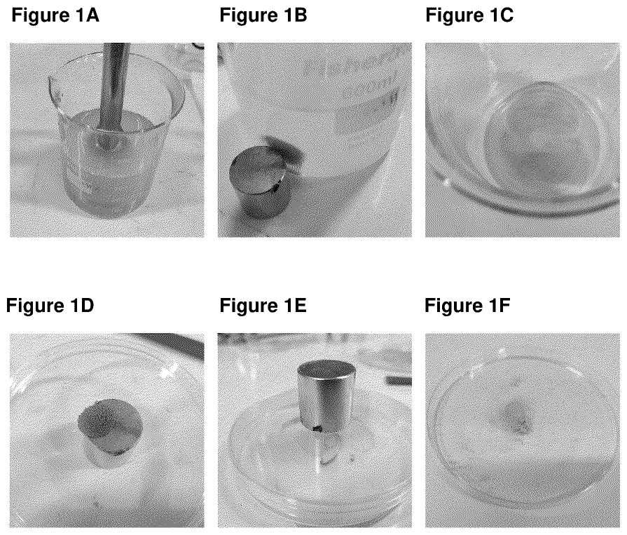

FIG. 1. ‘Blending’ methodology for the extraction of Silver coated ferrite particles from a printed water-based ink on a paper substrate;

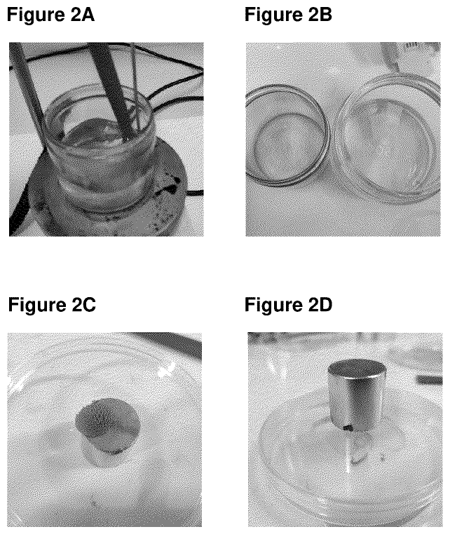

FIG. 2. ‘Mixing’ methodology for the extraction of Silver coated ferrite particles from a printed water-based ink on a paper substrate. This method could be used for recovery from plastic substrates;

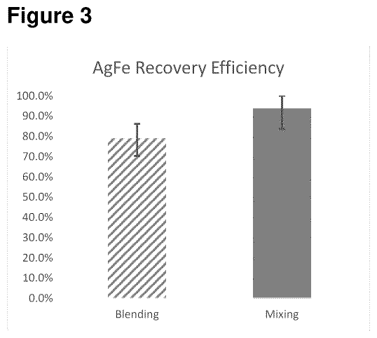

FIG. 3. Recovery Efficiency of Silver Coated Ferrite particles printed samples on paper comparing two different methods of extraction; and

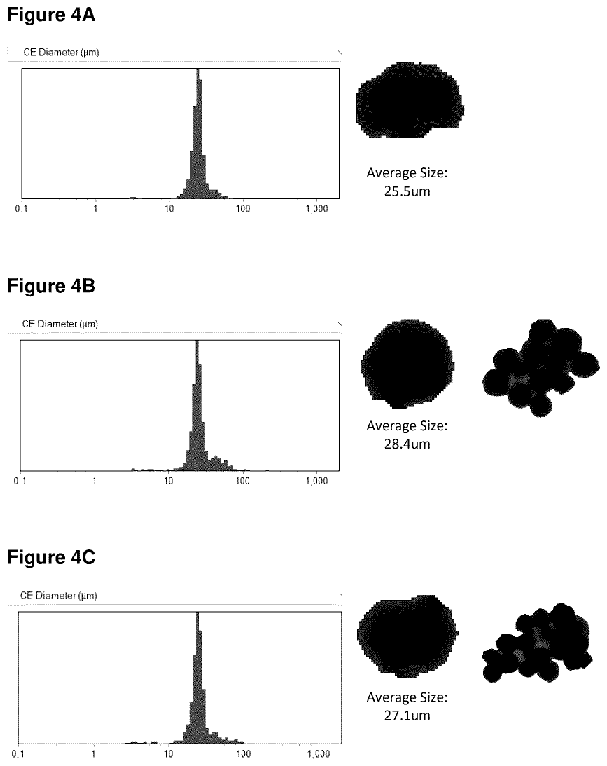

FIG. 4. Particle size distribution of the Silver Coated Ferrite produced using the Malvern Morphology 4 (left), an example of the average particle measured (centre) an example of combined fibre and multiple particles of AgFe (right). (a) Raw unprocessed AgFe particles (b) AgFe Particles recovered by blending (c) AgFe particles recovered by mixing

### EXAMPLE 1—INK FORMULATION

Printing inks typically comprise of functional materials dispersed in a resin. The resin provides the adhesion to the electronic substrate to which it is printed and the required rheological profile to support the functional material. A water-based resin system was used that could be printed onto both paper and plastic substrates. The resin comprised of 2.5% wt Sodium Carboxy Methyl Cellulose (CMC) Mw 90000 and 2.5% wt Pectin from citrus peel dissolved in Deionised (DI) water at 80° C. using a magnetic stirrer.

The conductive material selected for the ink was Silver-coated Ferrite (AgFe; Hart materials) with a silver content of 20% and a particle size of 25 μm. This material was selected for its magnetic and conductive properties, being typically used in EMI shielding and conductive tapes. The ferrite provides a lower density and less hazardous base material than nickel. The AgFe was added to the resin at 60% wt and allowed to wet for 12 hours. The ink was then milled using a pseudo-ball milling technique whereby glass beads were added to the ink before rolling the pot for 2 hours. The rheology of the resin, silver and AgFe inks was measured using the Netzsch Kinexus Pro Rheometer. The ink showed shear thinning behaviour with shear viscosity of between 45 and 4 Pa·s over a shear range of 0.1 to 100 s−1 respectively. The rheological profile of the ink would make it suitable for use with the screen printing process, which is commonly used in the printing of electronics.

To examine the suitability of AgFe inks for use in printed electronics, a comparison was made with Haydale flexible silver conductive ink, a commercial grade silver screen printing ink. Both inks were coated onto paper substrate (15 mm×210 mm) using an RK control coater. The samples were dried in an oven at 80° C. and the resistance was measured using a two point voltmeter at a distance of 50 mm. The AgFe had an average resistance of 2.7 Ohms compared with 1.7 Ohms for the commercial silver ink. Although the AgFe ink had a resistance nearly twice that of the silver ink, it is a viable alternative as a highly conductive ink. Additional printed layers or wider conductive tracks could be used to overcome these differences as well as optimisation of the ink design to improve the performance for printed electronics.

### EXAMPLE 2—RECOVERY METHODOLOGY

The use of a magnetic field to capture metal particles as they pass through a filter is commonly used to remove unwanted fragments for central heating systems, car transmissions and gas turbines. The recovery of the AgFe from the prints utilised the magnetic properties of the coating provided by the ferrite.

To determine the effectiveness of this method, ten samples of AgFe ink were coated onto paper substrate. The samples were weighed before and after coating to determine the volume of ink deposited onto the substrate and to allow the weight of AgFe in the coating to be determined. Two different methods for extraction of the AgFe were examined.

In the first method (Blending) (Error! Reference source not found.), the samples were submerged in a beaker of water at 80° C. before being blended using a hand blender to create the recovery media (a). A strong neo rhodium magnet was placed alongside the beaker to draw the AgFe particles from the solution (b). While maintaining the position of the magnet to keep the AgFe in place the paper/water solution was poured off (c). This process was repeated to remove paper that was contaminating the AgFe. The remaining AgFe sample was decanted into a petri dish using hot water to swill out the beaker (d). Using a magnet above the petri dish, the AgFe was pulled out of the water (e). The sample was then dried to determine the weight of AgFe recovered (f).

In a second method (Mixing) (FIG. 2), the samples were submerged in a beaker of water at 80° C. and mixed with a plastic spatula over a magnetic hotplate (a) to separate the AgFe ink from the paper substrate while maintaining the structure of the substrate. Using a neo-rhodium magnet, the AgFe was kept in the beaker while the water/paper solution was poured out (b). The remaining AgFe sample was decanted into a petri dish using hot water to swill out the beaker (c). Using a magnet above the petri dish, the AgFe was pulled out of the water and dried to determine the amount of material recovered (d).

Comparing the weight of the AgFe recovered from the samples with the weight of AgFe in the dried ink on the substrate, the efficiency of these two methods was determined (FIG. 3). The first (blending) method showed a lower recovery rate (78%) compared to the second (mixing) method (94%). This was due to the additional steps required to remove small traces of the paper substrate and fibres from the AgFe, caused by blending of the sample to form the recovery media. By maintaining the integrity of the substrate, the mixing method was able to avoid these steps to give a higher recovery rate. The mixing method could also be used to recover the AgFe particles from plastic substrates.

### EXAMPLE 3—PARTICLE SIZE DISTRIBUTION

The particle size distribution for the raw AgFe was compared with the recovered AgFe using the Malvern Morphology 4 (FIG. 4) from a sample of at least 1500 particles. The size distribution for the samples showed the highest peak in the same location, showing that the majority of particles are unchanged as a result of the magnetic recovery process. This would make them suitable to be reused into a new ink without further processing steps. There was an increase in the average particle size for the recovered AgFe samples. This was caused by an increase in the number of large particles, formed from a combination of silver particles and paper fibres. A smaller increase in the average particle size and fewer larger particles were seen in the sample obtained by the mixing method compared to the blending method.

### SUMMARY

Printed electronics provide a means to reduce the environmental impact of consumer electronics such as wearables, RFID aerials, energy harvesting, sensors and solar panels. The problem, as with conventional electronics, comes at the ‘end of life’ stage of the life cycle assessment. The means to recover the metals, such as silver, from electronics uses highly corrosive chemicals and result in denying the ability to recover the substrate onto which they are printed.

We demonstrate herein a formulation of a highly conductive silver ink for printed electronics which can be easily recycled with an efficiency of 94%. This was achieved by using silver coated ferrite (AgFe) particles, in place of silver flakes, to utilise the magnetic properties provided by the ferrite core for the extraction of the particles. Two methodologies were explored, which could be used to recover the AgFe and calculate the efficiency. Blending of the paper samples had a recovery efficiency of 78% compared with 94% by mixing. The difference was caused by the additional washing steps required to clean the AgFe particles from the paper fibres dissolved in the water from the blending process. The mixing process could also be used for plastic substrates.

A comparison was made between the particle sizing of the raw and recovered AgFe. An increase in the average particle size of the recovered AgFe was caused by the measurement of paper fibres. The AgFe recovered by mixing showed significantly fewer paper fibres and a smaller increase in the average particle size. The process of magnetic extraction did not cause any change to the particles, with the peak in the particle size distribution in the same location for the raw and recovered AgFe. This means that they could be reused to produce a new ink without any further processing steps.

Therefore, the ink disclosed herein, and associated recovery method possible in view of same, provides a solution to this problem of electronic wastes; using a specially formulated silver ink, which can be recovered from the printed electronics using hot water and magnets, we have demonstrated a recycling efficiency of 94%. The magnetic recovery of the silver does not change the particle size distribution and allows it to be reused in the formulation of a new ink without any further processing steps. The remaining substrate can also be processed through its own waste stream allowing for fully recyclable printed electronics.

### REFERENCES

[2] M. Mraović, T. Muck, M. Pivar, J. Trontelj and A. Pleteršek, “Humidity sensors printed on recycled paper and cardboard,” Sensors, no. 14(8), 2014.
[3] M. Ataeefard and S. Khamseh, “Design of conductive pattern on recycled paper,” Pigment & Resin Technology, 2019.
[4] B. Lee and S. Chung, “Printed carbon electronics get recycled,” Nature Electronics, vol. 4, no. 4, pp. 241-2, 2021.
[5] N. Williams, G. Bullard, N. Brooke, M. Therien and A. Franklin, “Printable and recyclable carbon electronics using crystalline nanocellulose dielectrics,” Nature Electronics, vol. 4, no. 4, pp. 261-8, 2021.
[6] A. Claypole, J. Claypole, L. Kilduff, D. Gethin and T. Claypole, “Stretchable Carbon and Silver Inks for Wearable Applications,” Nanomaterials, vol. 5, no. 11, 2021.

1. An ink composition comprising:
a. one or more coated magnetic particles;
b. one or more binders; and
c. one or more solvents,
wherein said particles are coated with one or more electrically conductive metals.

2. The ink composition according to claim 1, wherein said one or more coated magnetic particles comprise a magnetic metal core, wherein said magnetic metal core is optionally selected from iron, nickel and alloys thereof.

3. The ink composition according to claim 1, wherein said one or more electrically conductive metal is selected from silver, gold, copper, aluminium and alloys thereof.

4. The ink composition according to claim 3, wherein said one or more magnetic particles comprise iron or an iron alloy, and/or said electrically conductive metal is silver or an alloy thereof.

5. The ink composition according to claim 2, wherein the weight ratio of said magnetic metal core to said conductive metal is from about 5:95 to about 40:60.

6. The ink composition according claim 1, wherein said one or more coated magnetic particles are in an amount from about 40 to about 80 wt. %, based on the total weight of the ink composition.

7. The ink composition according claim 1, wherein said one or more coated magnetic particles have an average particle size of from about 10 μm to about 40 μm.

8. The ink composition according to claim 1, wherein said one or more binders comprises or consists of one or more hydrophilic polymer, and wherein said hydrophilic polymer is optionally selected from a polyvinyl alcohol, polyvinyl pyrrolidone, gelatin, cellulose, pectin, polyoxazoline, polyvinylacetamide, partially hydrolyzed polyvinyl acetate/vinyl alcohol, polyacrylic acid, polyacrylamide, polyalkylene oxide, sulfonated or phosphated polyester or polystyrene, casein, zein, albumin, and derivatives thereof.

9. The ink composition according to claim 8, wherein said one or more coated binders comprises one or more cellulose and/or one or more pectin.

10. The ink composition according to claim 1, wherein said one or more solvents is water.

11. The ink composition according to claim 1 wherein said ink composition is a shear thinning composition, and is optionally a shear thinning composition with a shear viscosity of between about 80 and about 2 Pa·s.

12. A substrate comprising an electrically conductive composition deposited thereon, wherein said composition comprises the ink composition according to claim 1.

13. The substrate according to claim 12, wherein said electrically conductive composition forms a conductive line, shape, pattern or circuit.

14. The substrate according to claim 12, wherein said electrically conductive composition is an adhesive composition in direct contact with, and thereby resiliently joining, said substrate and a surface mount component.

15. The substrate according to claim 12, wherein said conductive composition forms a conductive coating on the surface of the substrate.

16. The substrate according to claim 12, wherein said substrate is paper.

17. A method of printing an electrically conductive composition onto a substrate, said method comprising:
a. printing the ink composition according to claim 1 onto the surface of a substrate; and then
b. curing said ink composition.

18. The method according to claim 17, wherein said electrically conductive composition forms a conductive line, shape, pattern, circuit or coating.

19. The method according to claim 17, wherein said electrically conductive composition forms a conductive adhesive composition, and wherein said method comprises:
a. printing the ink composition according to claim 1 onto the surface of a substrate;
a1. depositing a surface mount component onto said printed ink composition; and then
b. curing said ink composition thereby resiliently joining the substrate and surface mount component.

20. The method according to claim 17, wherein:
(i) said ink is deposited onto the surface of the substrate in step (a) by screen printing; and/or
(ii) curing step (b) comprises the application of heat in order to accelerate the curing process.

21. A method for recycling conductive metal particles for re-use in a conductive ink composition, said method comprising:
a. providing a substrate according to claim 12;
b. submerging said substrate in a solvent to dissolve said substrate and/or the binder component of said cured ink composition, thereby forming a recovery media comprising free coated magnetic particles;
c. separating said conductive metal particles from the recovery media by the application of a magnetic force; and
d. optionally drying the recovered metal particles.

22. The method according to claim 21, wherein:
(i) said method further comprises a washing step after separation step (c) and, if present, prior to drying step (d);
(ii) said solvent is water; and/or
(iii) said solvent is heated to a temperature of from about 50° C. to about 90° C. in step (b).

23. The method according to claim 21, wherein said method further comprises, after step (c) and, if present, step (d), combining the recovered conductive metal particles with one or more binders and one or more solvents to prepare the ink composition.
